(19) United States
(12) Patent Application Publication
(10) Pub. No.: US 2021/0268323 A1
(43) Pub. Date: Sep. 2, 2021

(54) ASSEMBLY, SYSTEM AND METHOD FOR TESTING A SPRINKLER SYSTEM

(71) Applicant: PROJECT FIRE GLOBAL HOLDINGS LIMITED, Stoke on Trent, Staffordshire (GB)

(72) Inventor: Stuart CAIN, Brocton, Staffordshire (GB)

(21) Appl. No.: 16/093,130

(22) PCT Filed: Apr. 10, 2017
(86) PCT No.: PCT/GB2017/050995

§ 371 Date: Oct. 11, 2018

(30) Foreign Application Priority Data
Apr. 12, 2016 (GB) 1606263.0

(51) Int. Cl. A62C 37/50

(52) U.S. Cl. CPC A62C 37/50

(57) ABSTRACT

A testing apparatus (11) for testing a fire sprinkler system combines components for testing both the function of a tamper switch (not shown) incorporated into local zone valve (18) and the working of a flow switch (12) that detects flow in a pipe (13). The assembly (10) also comprises a module (19) which is connected to the flow switch (12), the pump (16) and the local zone valve (18) to monitor their performance. A master controller (20) is provided for reading data from the module (19) and for instructing the module (19) to control the operation of the various components of the testing apparatus (11) connected thereto. Information received by the master controller (20) can be relayed to a building's fire alarm panel (21). In normal use, the module (19) will transmit signals to the master controller (20) to activate the fire alarm via the fire alarm panel (21) in response to monitoring of the flow switch (12) and zone valve (18). In test mode, the module (19) is operable to disable the alarm being activated. This allows testing to take place without generating false alarms. The module (19) can also correlate the date and time of the test with the outcome of the test (i.e. pass or fail) and send this information to the master controller (20) for printing or archiving.

### TECHNICAL FIELD OF THE INVENTION

The present invention relates to a sprinkler system and in particular to an assembly, a system and a method for testing the working of a component of a sprinkler system.

### BACKGROUND TO THE INVENTION

Fire sprinkler systems typically comprise a plurality of sprinklers that activate automatically in response to a predetermined high temperature. The sprinklers are connected to a flow switch that outputs a signal to activate a fire alarm if a flow of water is detected over the switch. Thus, a fire alarm sounds if one of the sprinklers in the system activates. Sprinklers in the same area, such as a floor of a building, are usually connected to the same flow switch in order to minimise the complexity of the sprinkler system. Fire sprinkler systems, and in particular their flow switches, need to be routinely tested to ensure that they are in good working order.

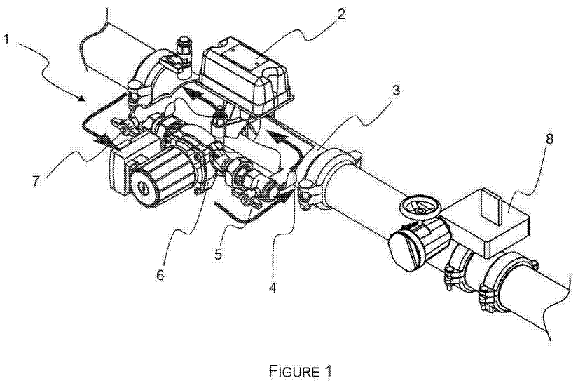

FIG. 1 illustrates a known testing apparatus 1 for testing a fire sprinkler system. In particular, the testing apparatus 1 tests the working of a flow switch 2 that detects flow in a water inlet pipe 3. The testing apparatus 1 comprises additional pipework 4 that defines a loop, which allows water to flow over the flow switch 2 without it flowing around the other parts of the fire sprinkler system. A pump 6 is provided for pumping water through the additional pipework 4 and round the loop. Two shut-off valves 5, 7 are also provided. When the pump 6 operates, it circulates water around the loop, through the pipe 3 and the additional pipework 4, and thus over the flow switch 2. If the flow switch 2 detects the water flow then it is determined to be functioning correctly. If the flow switch 2 does not detect the water flow then it is determined to be functioning incorrectly and must be replaced or repaired. Accordingly, this known testing apparatus 1 provides a relatively simple way of testing the flow switch 2 without circulating water through other parts of the sprinkler system.

However, during the testing, since water flows over the flow switch 2, the fire alarm will activate and prompt an unnecessary evacuation, which causes a disruption. This can unfortunately lead to inadequate or infrequent testing of a sprinkler system because a user may want to minimise such disruptions.

The testing apparatus typically incorporates a local zone valve 8 operable to enable the isolation of a local zone of the sprinkler system for repair, maintenance or the like. Zone valve 8 is intended to remain open at all times other than during repair or maintenance. In order that the position of the zone valve 8 can be verified, it is typically fitted with a tamper switch operable to output a tamper signal if the zone valve 8 is in the closed position. Output of the tamper signal can in turn trigger the output of an alarm at a central control panel.

In order to test the tamper switch is operation, the zone valve 8 is periodically shut, say every 3 to six months. This operation should in turn trigger the tamper signal and the associated alarm. As with the flow switch test above, triggering of such alarms can cause disruption. Furthermore, as the zone valve 8 and the central control panel are typically located some distance apart, two workers are required to conduct the test, one to operate the zone valve 8 and one to verify alarm operation. These issues can lead to inadequate or infrequent testing of a sprinkler system because a user may want to minimise such disruptions or the costs associated with hiring suitable workers.

In addition, with known systems, it is not possible to ensure or prove that a fire sprinkler system has actually been tested since test data is not reported or recorded. Thus, a user may fabricate data to falsely show that their sprinkler system has been routinely tested.

Embodiments of the present invention seek to address the above problems.

### SUMMARY OF THE INVENTION

According to a first aspect of the invention, there is provided an assembly for testing a sprinkler system, the assembly comprising: testing apparatus; and a module, wherein the module is linked to the testing apparatus and is operable to: implement the test using the testing apparatus; report an outcome of the test; and disable activation of a connected fire alarm during the test.

In this way, the present invention provides an assembly where, when instructed to do so, a module uses the testing apparatus to conduct a test of a fire sprinkler system and reports the outcome of the test, e.g. pass or fail, whilst at the same time momentarily disabling activation of the fire alarm to prevent an unwanted evacuation from a building housing the sprinkler system. Accordingly, the present invention encourages users to test their sprinkler system since testing does not cause any unnecessary disruptions and the test reports can be used to prove whether or not a sprinkler system has actually been routinely tested.

The module may control the test apparatus that tests the fire sprinkler system.

The test may be a test to check that a part of the sprinkler system is functioning correctly.

In some embodiments, the test may be to check that a tamper switch associated with a local zone valve is functioning correctly. The zone valve may be an isolation valve operable when in the closed position to isolate an associated zone of the sprinkler system from a water supply. Accordingly, it is critically important that the tamper switches associated with zone valves of a fire sprinkler system are open so that water can be supplied to each zone if the system is activated.

The tamper switch may be operable to output a tamper signal in response to the zone valve being moved to the closed position. In non-testing operation, the tamper signal may be operable to trigger an alarm. In this way, the module can alert the user if the local zone valve is closed or not fully open.

In such embodiments, the testing apparatus may comprise an actuator operable to drive the zone valve between the open and closed positions. The actuator may comprise an electric motor or the like. The actuator may be operable in response to signals from the module. The actuator may be provided in addition to or in place of a manually driven wheel.

In some embodiments, the test may be to check that a flow switch is functioning correctly. In this respect, each sprinkler in a fire sprinkler system activates in response to an increased temperature and a fire alarm then sounds if a flow switch in the system detects that water is flowing in a part of the system due to a sprinkler activating. Accordingly, it is critically important that the flow switches of a fire sprinkler system are working as intended so that the fire alarm will sound when needed.

In some embodiments, the test may be a test to check that an alarm valve is functioning correctly. In this respect, an alarm valve in a sprinkler system is designed to activate a fire alarm when a sprinkler head discharges water. The alarm valve activates due to flow of water in the sprinkler system triggering the clack, which is a pivotable lever in a pipe of the sprinkler system. Accordingly, it is critically important that the alarm valve or valves of a fire sprinkler system are working as intended so that the fire alarm will sound when needed.

In some embodiments, the testing apparatus may comprise additional pipework that defines a loop, which includes a pipe in which a flow switch or alarm valve is located. The loop of the testing apparatus thus allows water to flow over the flow switch or alarm valve without the water flowing around the other parts of the fire sprinkler system. The testing apparatus may comprise a pump for pumping water through the additional pipework. The testing apparatus may comprise one or more valves in the additional pipework. In this way, when the pump operates, it circulates water around the loop, through the additional pipework and the pipe in which the flow switch or alarm valve is positioned, and thus over the flow switch or alarm valve so that the working order of the flow switch or alarm valve can be tested.

The module may be further operable to record the date and/or time of a test. In this way, since the module records the date and time that a test has been run, it is possible to prove or disprove a user's claimed records of testing their sprinkler system. Accordingly, safety is improved because the record keeping strongly encourages a user to regularly run tests of the sprinkler system.

The module may be further operable to record the outcome of a test. In this way, the module records whether the sprinkler system, or component thereof, has passed each and every test. Accordingly, it is possible to show if and when a sprinkler system has passed and/or failed a test.

The module may be further operable to archive the outcome of a test. Thus, the module may further comprise or be connected to one or more mediums for storing data, such as a hard disk, solid state memory or the like. The medium for storing data may be local to the module and/or may be remote from the module. In this way, the outcomes of a test are backed up in case the module is damaged, for example in a fire.

The module may be connected to a local output device such as a printer for printing the data of a test.

The module may further comprise or be connected to a communication unit. The communication unit may be operable to send and/or receive data, such as test data, to and from a remote system or server. The communication unit may be operable to send and/or receive control signals to and from a remote system or server. The communication unit may be operable to communicate data over any suitable wired or wireless link.

The module may further comprise a user interface for initialising the test and/or operable in response to received control signals. The module may further comprise a display for displaying the user interface. The module and/or the display may comprise user actuable controls for allowing the user to interact with the user interface.

According to a second aspect of the invention, there is provided a system comprising: one or more assemblies according to the first aspect of the invention; and a master controller.

In this way, a master controller is provided to centrally control the operation of the one or more testing apparatuses and read data from the one or more respective modules. Accordingly the master controller may conduct the entire test routine without the need for a user to intervene, such as turn a key or isolate an alarm.

The system may comprise a plurality of assemblies according to the first aspect of the invention.

The system may further comprise a fire alarm panel for activating a fire alarm in response to a signal from the master controller.

Each module may be linked to the master controller. The link may comprise a wireless link. More preferably, the link may comprise a wired link. This can provide a more robust and reliable link than a wireless link. Each module may be linked to the master controller by two paths. In this way, the system provides for double point failure such that if a first path between a module and the controller is broken or damaged, the module can still communicate with the master controller by using the second path. This provides an extra layer of protection to ensure that the system can thoroughly test the fire sprinkler system, even when damaged. The links may comprise wired or wireless links.

Where the system comprises multiple modules, each module may be linked to the master controller by a path via another of the modules. Thus, each module may be linked to the master controller indirectly. At the same time, one or more of the modules may also be linked to the master controller directly. For example where the system comprises a first module and a second module, the first module may be linked to the master controller and to the second module. Thus, the second module is indirectly linked to the master controller through the first module.

The module and/or the master controller may be operable to detect when a link between the module and the master controller has been severed. In this way, a fault signal may be sent to the master controller to indicate that the link has been severed so that the problem can be identified and repaired.

The system may further comprise a local output device connected to the master controller. The local output device may be a display or may be a printer. In this way, the master controller can output the results of the test so that they can be read by a user or a physical copy may be stored as a record of the test.

The system may further comprise a communication unit operable to communicate test data to a remote device, such as a server, or to a remote data store. The communication unit may be operable to communicate test data to the internet or to internet storage such as the cloud. The communication unit may be operable to receive control signals from a remote device.

The master controller may be operable to initiate tests at specific time intervals. In one example tests may be initiated daily, weekly or monthly. The master controller may be operable to initiate tests of the whole system or of specific aspects or zones of a system. The master controller may be operable to imitate particular tests in response to specific user inputs or to vary the initiation schedule of particular tests in response to specific user inputs. This can allow a user to initiate tests or all or specific parts of a system at a convenient time.

The system may further comprise one or more valve sensors. Each valve sensor may be linked to the master controller. Each valve sensor may be connected to a valve in the system. Each valve sensor may be operable to detect the position of the valve and thus whether the valve is open or closed. In this way, the system may be operable to determine if a valve in the system is in an incorrect position and may transmit this information to the master controller.

The system may further comprise one or more level sensors. The one or more level sensors may each be connected to a tank in the system, such as a water tank. The one or more level sensors may be linked to the master controller. The one or more level sensors may each be linked to an alarm. The one or more level sensors may comprise one or more high level sensors for detecting a high level in a tank. The one or more level sensors may comprise one or more low level sensors for detecting a low level in a tank. In this way, the system may be operable to determine if the level in a tank in the system is too high or too low and may transmit this information to the master controller.

The system may further comprise one or more trace heating sensors for detecting damage to trace heating within the system. The system may further comprise one or more trace lagging sensors for detecting damage to trace lagging within the system. The one or more trace heating sensors and/or the one or more trace lagging sensors may be linked to the master controller. In this way, the system may be operable to determine if trace heating and/or trace lagging within the system has been damaged and is not functioning correctly, and may transmit this information to the master controller.

The system may further comprise one or more sensors connected to a valve in the system for detecting whether the valve is functioning correctly. The system may further comprise one or more sensors connected to a pressure switch in the system for detecting whether the pressure switch is functioning correctly. The system may further comprise one or more sensors connected to a flow switch in the system for detecting whether the flow switch is functioning correctly. The one or more sensors may be linked to the master controller. The one or more sensors may each be linked to an alarm that may be connected to a valve, pressure switch or flow switch and may activate if the valve, pressure switch or flow switch is not functioning correctly. In this way, the sensors may be operable to determine if a valve, pressure switch, and/or flow switch within the system has been damaged and is not functioning correctly, and may transmit this information to the master controller.

The system may further comprise an electrical power sensor for detecting whether electrical power is being supplied to the system or to a part of the system. The electrical power sensor may be linked to the master controller. In this way, the system may be operable to determine whether electrical power is being correctly supplied to the system, or to a part of the system, and may transmit this information to the master controller.

The system may further comprise one or more temperature sensors for measuring the temperature of a room in which the master controller and/or a module is operating in. The one or more temperature sensors may be linked to the master controller. In this way, the system may be operable to determine whether the temperature of a room in which a part of the system is operating is too high or too low, and may transmit this information to the master controller.

The second aspect of the invention may comprise any feature of the first aspect of the invention.

According to a third aspect of the invention, there is provided a method of testing a sprinkler system using a system according to the second aspect of the invention, the method comprising the steps of:
the master controller instructing the module of an assembly to begin the test;
the module of an assembly testing the sprinkler system by operating the testing apparatus; and
the module reporting the results of the test to the master controller.

The third aspect of the invention may comprise any feature of the first or second aspects of the invention.

### DETAILED DESCRIPTION OF THE INVENTION

In order that the invention may be more clearly understood embodiments thereof will now be described, by way of example only, with reference to the accompanying drawings, of which:

FIG. 1 is a perspective view of a known testing apparatus for testing a flow switch of a fire sprinkler system;

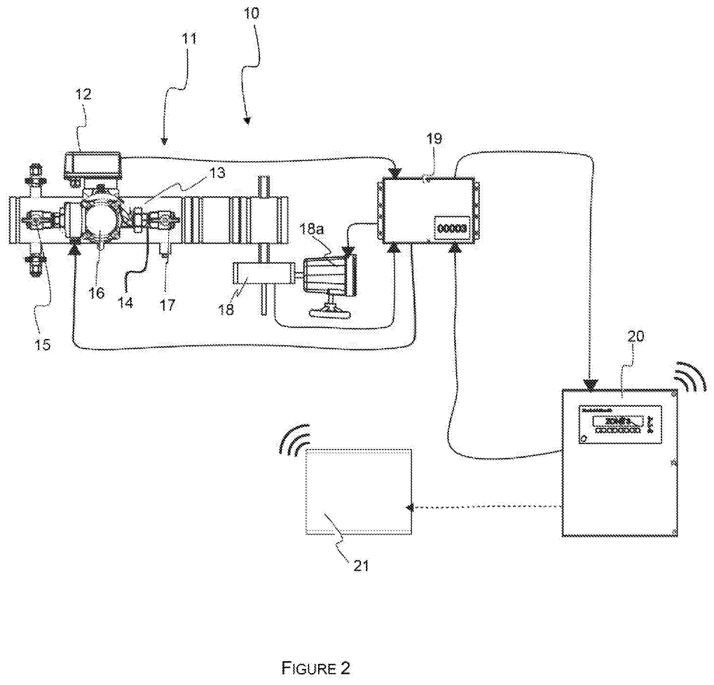

FIG. 2 is a schematic of a system according to a first embodiment of the invention;

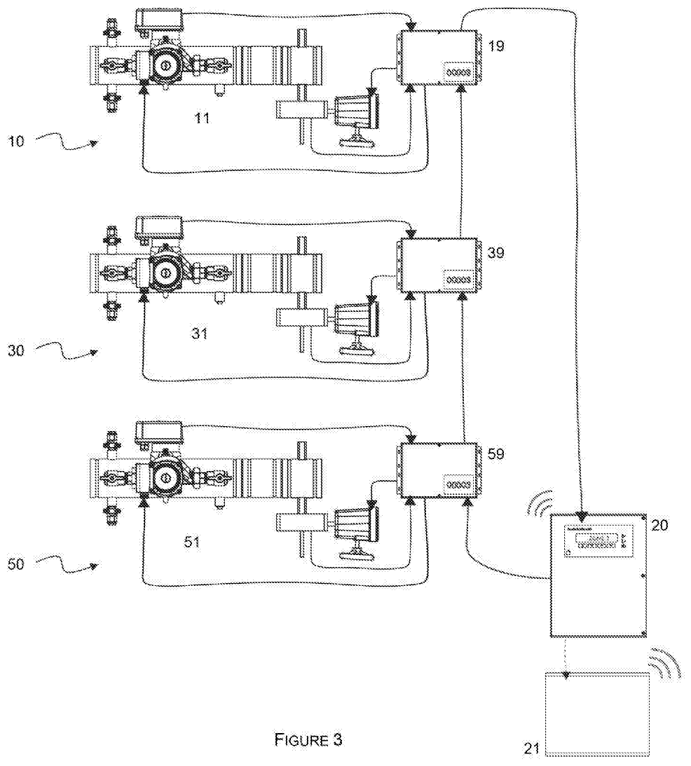

FIG. 3 is a schematic of a system according to a second embodiment of the invention; and

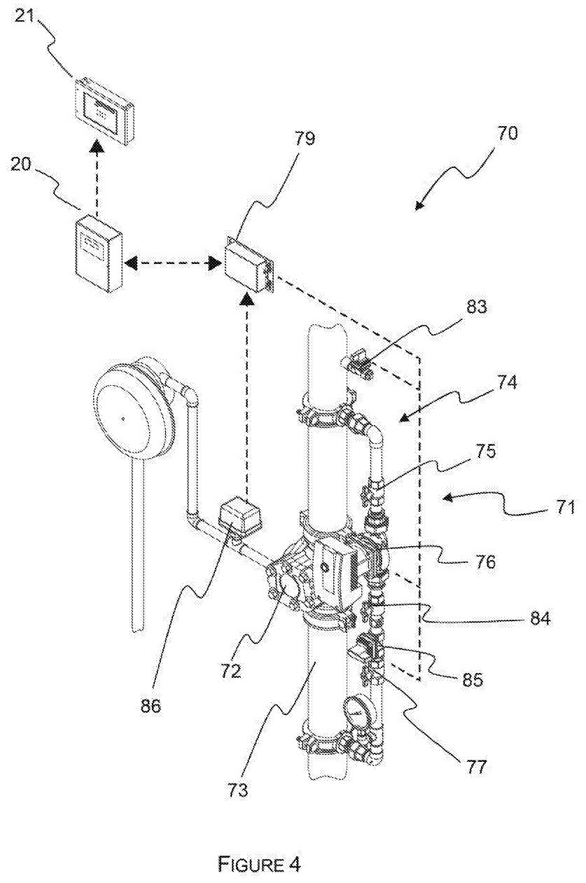

FIG. 4 is a schematic of a system according to a third aspect of the invention.

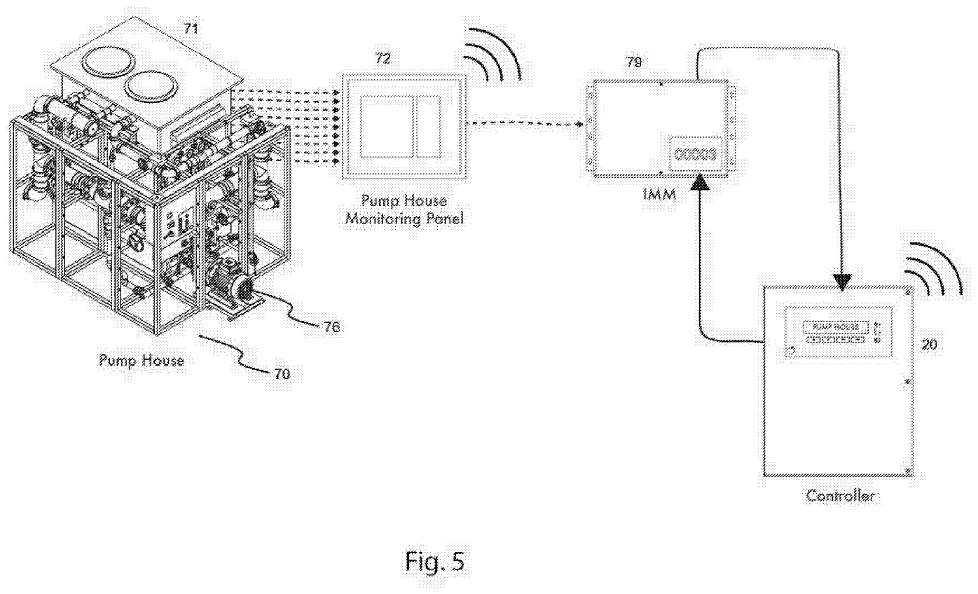

FIG. 5 is a schematic of a system according to the invention incorporating pump house monitoring.

FIG. 1 is discussed above in the “Background to the Invention” and illustrates a testing apparatus 1 for testing a flow switch 2 of a fire sprinkler system according to the prior art.

Referring to FIG. 2, an assembly 10 comprises a testing apparatus 11 for testing a fire sprinkler system. In the particular example shown, the testing apparatus 11 combines components for testing both the function of a tamper switch (not shown) incorporated into local zone valve 18 and the working of a flow switch 12 that detects flow in a pipe 13.

In a typical sprinkler system the pipe 13 containing the flow switch 12 is a water inlet pipe that supplies water to a plurality of sprinklers. In normal use, the local zone valve 18 must be left open to allow for water to be supplied automatically to the sprinklers when required.

For testing the zone valve 18, the testing apparatus comprises the tamper switch and an actuator 18a, typically an electric motor. The actuator 18a is, operable to drive the zone valve between the open and closed positions, such that a tamper signal is generated by the tamper switch. Generation of the tamper signal can verify the operation of the tamper switch. Subsequently actuator 18a can reopen the zone valve 18.

For testing the flow switch, the testing apparatus 11 comprises additional pipework 14 that defines a loop, which allows water to flow over the flow switch 12 without it flowing around the other parts of the fire sprinkler system. A pump 16 is provided for pumping water through the additional pipework 14. Two shut-off valves 15, 17 and a local zone valve 18 are also provided. When the pump 16 operates, it circulates water around the loop, through the pipe 13 and the additional pipework 14, and thus over the flow switch 12. If the flow switch 12 detects the water flow then it is functioning correctly. If the flow switch 12 does not detect the water flow within a set time limit then it is not functioning correctly and must be replaced or repaired.

The assembly 10 also comprises a module 19 which in this embodiment is an intelligent monitoring module. The module 19 is connected to the flow switch 12, the pump 16 and the local zone valve 18 to monitor their performance.

A master controller 20 is provided for reading data from the module 19 and for instructing the module 19 to control the operation of the various components of the testing apparatus 11 connected thereto. Information received by the master controller 20 can be relayed to a building's fire alarm panel 21 if required.

Referring to FIG. 3, a system 22 comprises a plurality of assemblies 10, 30, 50. A first assembly 10 comprises a first testing apparatus 11 connected to a first module 19. A second assembly 30 comprises a second testing apparatus 31 connected to a second module 39. A third assembly 50 comprises a third testing apparatus 51 connected to a third module 59. The system 22 also comprises a master controller 20 and a fire alarm panel 21 connected to the master controller 20.

The testing apparatuses 11, 31, 51, modules 19, 39, 59, master controller 20 and fire alarm panel 21 are substantially as described above with respect to the first embodiment.

Thus, the second testing apparatus 31 comprises a tamper switch incorporated into zone valve 38 and an actuator 38a operable to drive the zone valve 38a between the open and closed positions as well as a second pump 36 for circulating water around additional pipework 34 to test the working of a second flow switch 32. Similarly, the third testing apparatus 51 comprises a tamper switch incorporated into zone valve 58 and an actuator 58a operable to drive the zone valve 58a between the open and closed positions as well as a third pump 56 for circulating water around additional pipework 54 to test the working of a third flow switch 52. These reference numerals, and those of the first assembly 10, are not shown in FIG. 3 in order to improve its clarity.

With this second embodiment, the first module 19 is connected to the first testing apparatus 11 and the master controller 20 and additionally to the second module 39. The second module 39 is connected to the second testing apparatus 31, the first module 19 and the third module 59. The third module 59 is connected to the third testing apparatus 51, the second module 39 and the master controller 20.

Accordingly, each of the modules 19, 39, 59 are connected to the master controller 20 via two paths. For example, the first module 19 is connected directly to the master controller 20 but is also connected indirectly to the master controller 20 by a second path via both the second module 39 and the third module 59. This provides for double point failure. Thus, if, for example, the direct link between the first module 19 and the master controller 20 was damaged and no longer usable, the first module 19 could still communicate with the master controller 20 indirectly by using the second path via the second module 39 and the third module 59. An extra layer of protection is therefore provided.

In use, the assemblies 10, 30, 50 are positioned in different areas of a building to test the operation of zone valves 18, 38, 58 and flow switches 12, 32, 52 in different areas of the building. For example, the first assembly 10 may be located to test a zone valve 18 and a flow switch 12 in a pipe 13 that supplies water to the sprinklers on a first floor of a building. The second assembly 30 may be located to test a zone valve 38 and a flow switch 32 in a pipe 33 that supplies water to the sprinklers on a second floor of a building. The third assembly 50 may be located to test a zone valve 58 and a flow switch 52 in a pipe 53 that supplies water to the sprinklers on a third floor of a building.

The master controller 20 manages and implements a testing method to use the assemblies 10, 30, 50 to test the working order of each of the zone valves 18, 38, 58 and flow switches 12, 32, 52.

In use, the master controller 20 transmits a “test” command to each of the modules 19, 39, 59 of the system 22. The “test” command may indicate whether the test should relate to both the zone valves 18, 38, 58 and flow switches 12, 32, 52 or to either separately. In some embodiments, the “test” command may include identifying particular module 19, 39, 59 to initiate tests.

For testing the zone valves 18, 38, 58 each module 19, 39, 59 activates the associated actuator 18a, 38a, 58a to drive the zone valves 18, 38, 58 to the closed position. In response to being closed, the tamper switches associated with each zone valve 18, 38, 58 should output a tamper signal to the connected module 19, 39, 59.

In normal use, this tamper signal may be sent on to the master controller 20 to activate the fire alarm via the fire alarm panel 21. However, after the “test” command has been transmitted, during testing each module 19, 39, 59 is operable in response to disable the alarm being activated.

If the connected module 19, 39, 59 receives a tamper signal, it recognises that the zone valve 18, 38, 58 is functioning correctly and therefore awards the zone valve 18, 38, 58 a “pass”. The module 19, 39, 59 transmits this information to the master controller 20. Subsequently, the modules 19, 39, 59 operate actuators 18a, 38a, 58a to open the respective zone valves 18, 38, 58 to end the test of that particular valve.

If a tamper switch associated with and of the zone valves 18, 38, 58 does not output a tamper signal then its connected module 19, 39, 59 recognises that the zone valve 18, 38, 58 may be damaged and in need of replacement or repair and therefore awards the zone valve 18, 38, 58 a “fail”. Similarly, if a zone valve 18, 38, 58 does not output a tamper signal within a specified period of closure, then its connected module also awards the zone valve 18, 38, 58 a “fail”. The module 19, 39, 59 transmits this information to the master controller 20. Subsequently, the modules 19, 39, 59 operate actuators 18a, 38a, 58a to open the respective zone valves 18, 38, 58 to end the test of that particular valve. The master controller 20 may then instruct the fire alarm panel 21 to alert the user to the problem, by using, for example, a visual alert and/or audible alert.

When the testing of a particular zone valve 18, 38, 58 has finished, its respective module is operable to cancel the disabling of the fire alarm so that it can once again sound if the zone valve 18, 38, 58 is closed.

For testing the flow switches 12, 32, 52 each module 19, 39, 59 then activates the pump 16, 36, 56 of its connected testing apparatus 11, 31, 51 to begin testing the flow switches 12, 32, 52. Each pump 16, 36, 56 then circulates water in a loop comprising the pipe 13, 33, 53 in which the flow switch to be tested 12, 32, 52 is located and the additional pipework 14, 34, 54 of the testing apparatus 11, 31, 51.

As water is now flowing within each pipe 13, 33, 53, each flow switch 12, 32, 52 should detect the water flow and send a signal to its connected module 19, 39, 59 to indicate that the water flow has been detected.

In normal use, this signal may be sent on to the master controller 20 to activate the fire alarm via the fire alarm panel 21. However, after the “test” command has been transmitted, during testing each module 19, 39, 59 is operable in response to disable the alarm being activated.

When a flow switch 12, 32, 52 detects the water flow during the test then the connected module 19, 39, 59 recognises that the flow switch 12, 32, 52 is functioning correctly and therefore awards the flow switch 12, 32, 52 a “pass”. The module 19, 39, 59 transmits this information to the master controller 20, which switches off the respective pump 16, 36, 56 to end the test of that particular flow switch.

If a flow switch 12, 32, 52 does not detect the water flow then its connected module 19, 39, 59 recognises that the flow switch 12, 32, 52 may be damaged and in need of replacement or repair and therefore awards the flow switch 12, 32, 52 a “fail”. Similarly, if a flow switch 12, 32, 52 does detect the water flow, but does not detect it within a specified period (i.e. the flow switch 12, 32, 52 is too slow) then its connected module also awards the flow switch 12, 32, 52 a “fail”. The module 19, 39, 59 transmits this information to the master controller 20, which switches off the pump 16, 36, 56 to end the test of that particular flow switch. The master controller 20 may then instruct the fire alarm panel 21 to alert the user to the problem, by using, for example, a visual alert and/or audible alert.

When the testing of a particular flow switch 12, 32, 52 has finished, its respective module is operable to cancel the disabling of the fire alarm so that it can once again sound if the flow switch 12, 32, 52 detects water flow.

In addition, each module 19, 39, 59 records the date and time of the test and relays this information back to the master controller 20. Each module 19, 39, 59 can also correlate the date and time of the test with the outcome of the test (i.e. pass or fail) and send this information to the master controller 20. A local output device such as a printer may then be connected to the master controller 20 for printing out the sprinkler system test records.

It should be noted that each assembly 10, 30, 50 carries out the test of its zone valve 18, 38, 58 and flow switch 12, 32, 52 independently of the other assemblies.

Referring to FIG. 4, an assembly 70 comprises a testing apparatus 71 for testing a fire sprinkler system. In particular, the testing apparatus 71 tests the working of an alarm valve 72 that detects flow in a pipe 73. In a typical sprinkler system the pipe 73 containing the alarm valve 72 is a water inlet pipe that supplies water to a plurality of sprinklers.

The testing apparatus 71 comprises additional pipework 74 that defines a loop, which allows water to flow over the alarm valve 72 whilst minimising the amount of water expelled to drain from the fire sprinkler system. A pump 76 is provided for pumping water through the additional pipework 74. Three shut-off valves 75, 77, 84 and a solenoid valve 85 are also provided. The solenoid valve 85 is normally closed to prevent water from flowing around the loop and bypassing the alarm valve 72. With the solenoid valve 85 open, when the pump 76 operates, it circulates water around the loop, through the pipe 73 and the additional pipework 74, and thus over the alarm valve 72. If the alarm valve 72 detects the water flow then it is functioning correctly. If the alarm valve 72 does not detect the water flow within a set time limit then it is not functioning correctly and must be replaced or repaired.

The assembly 70 also comprises a module 79 which in this embodiment is an intelligent monitoring module. The module 79 is connected to a pressure switch 86 that is configured to monitor activation of the alarm valve 72 and the pump 76.

A master controller 20 is provided for reading data from the module 79 and for instructing the module 79 to control the operation of the various components of the testing apparatus 71 connected thereto. Information received by the master controller 20 can be relayed to a building's fire alarm panel 21 if required.

In use, the master controller 20 transmits a “test” command to the module 79. The module 79 then opens the solenoid valve 85 and activates the pump 76 of the connected testing apparatus 71 to begin testing the alarm valve 72. The pump 76 then circulates water in a loop comprising the pipe 73 in which the alarm valve to be tested 72 is located and the additional pipework 74 of the testing apparatus 71.

As water is now flowing within the pipe 73, the alarm valve 72 should detect the water flow by lifting a clack. The pressure switch 86 detects a change in pressure in the pipe 73 caused by the clack lifting and sends a signal to the module 79 to indicate that the water flow has been detected.

In normal use, this signal may be sent on to the master controller 20 to activate the fire alarm via the fire alarm panel 21. However, after the “test” command has been transmitted, during testing the module 79 is operable in response to disable the alarm being activated.

When the alarm valve 72 detects the water flow during the test then the connected module 79 recognises that the alarm valve 72 is functioning correctly and therefore awards the alarm valve 72 a “pass”. The module 79 transmits this information to the master controller 20, which closes the solenoid valve 85 and switches off the pump 76 to end the test of the alarm valve 72.

If the pressure switch 86 does not detect the water flow then the module 79 recognises that the alarm valve 72 may be damaged and in need of replacement or repair and therefore awards the alarm valve 72 a “fail”. Similarly, if the alarm valve 72 does detect the water flow, but does not detect it within a specified period (i.e. the alarm valve 72 is too slow) then the module 79 also awards the alarm valve 72 a “fail”. The module 79 transmits this information to the master controller 20, which closes the solenoid valve 85 and switches off the pump 76 to end the test of the alarm valve 72. The master controller 20 may then alert the user to the problem, by using, for example, a visual alert and/or audible alert.

When the testing of the alarm valve 72 has finished, the module 79 is operable to cancel the disabling of the fire alarm so that it can once again sound if the alarm valve 72 detects water flow.

In addition, the module 79 records the date and time of the test and relays this information back to the master controller 20. The module 79 can also correlate the date and time of the test with the outcome of the test (i.e. pass or fail) and send this information to the master controller 20. A local output device such as a printer may then be connected to the master controller 20 for printing out the sprinkler system test records.

Turning now to FIG. 5, a further optional aspect of the system is shown. In this instance the system additionally provides for monitoring of the stored water level in a water tank 71 of a pump house 70 incorporated into the system. The water tank 71 enables a store of water to be maintained to supply sprinklers throughout the system in the event of fire. This provides a boost and/or back up to the mains water supply during operation.

The tank 71 is provided with one or more level sensors (not shown individually). The one or more level sensors are linked to the master controller 20 via a pump house zone module 79. The individual level sensors may be each operable to output a signal indicative of whether the water level in the tank 71 is above or below the level sensor. In this way the water level in tank 71 can be determined.

In the event that the water level in the tank 71 is determined to be too high, for instance above the uppermost level sensors or too low, for instance below the lower most level sensors, an alarm can be output.

In a similar manner, the Pump House Monitoring panel, 72, can monitor a number of signals from a standard pump house setup. This could include, but not be limited to pressure-switches, level gauges, temperature gauges and valve positions. Each of these items, within the pump house, 70, can transmit a signal to the pump house monitoring panel 72 which will transfer the fault signal via the Pump House module 79 to the master controller 20.

The above embodiments are described by way of example only. Many variations are possible without departing from the scope of the invention as defined in the appended claims.

For example, multiple assemblies of the third embodiment of the invention may be arranged in a system in line with the second embodiment of the invention.

1. An assembly for testing a sprinkler system, the assembly comprising:
testing apparatus; and a module,
wherein the module is linked to the testing apparatus and is operable to:
implement the test using the testing apparatus; report an outcome of the test; and
disable activation of a connected fire alarm during the test.

2. An assembly according to claim 1 wherein the assembly is for testing that a tamper switch associated with a local zone valve is functioning correctly.

3. An assembly according to claim 2 wherein the tamper switch is operable to output a tamper signal in response to the zone valve being moved to the closed position.

4. An assembly according to claim 2 wherein the testing apparatus comprises an actuator operable to drive the zone valve between the open and closed positions.

5. An assembly according to claim 4 wherein the actuator is operable in response to signals from the module.

6. An assembly according to claim 1, wherein the assembly is for testing that a flow switch is functioning correctly; and or that an alarm valve is functioning correctly.

7. (canceled)

8. An assembly according to claim 1, wherein the testing apparatus comprises additional pipework that defines a loop, which includes a pipe in which a flow switch or alarm valve is located; and a pump for pumping water through the additional pipework and thus around the loop and over the flow switch or alarm valve so that the working order of the flow switch or alarm valve can be tested.

9. An assembly according to claim 1, wherein module is further operable to record the date and/or time of a test of the sprinkler system; and/or to record the outcome of a test of the sprinkler system.

10. (canceled)

11. An assembly according to claim 9, wherein the module is further operable to archive the outcome of a test.

12. An assembly according to claim 1, wherein the module further comprises or is connected to a medium for storing data; and/or a communication unit operable to send and/or receive test data and/or control signals to and from a remote system.

13. An assembly according to claim 1, wherein the module is connected to a local output device such as a printer for printing the data of a test.

14. (canceled)

15. An assembly according to claim 1, wherein the module further comprises a user interface.

16. A system comprising:
one or more assemblies for testing a sprinkler system, and
a master controller;
each assembly comprising: testing apparatus; and a module, wherein the module is linked to the testing apparatus and is operable to: implement the test using the testing apparatus; report an outcome of the test and disable activation of a connected fire alarm during the test.

17. (canceled)

18. A system according to claim 16, further comprising a fire alarm panel for activating a fire alarm in response to a signal from the master controller.

19. A system according to claim 16, wherein each module is linked to the master controller; or to the master controller by two paths.

20. (canceled)

21. (canceled)

22. A system according to claim 16, wherein the module and/or the master controller is operable to detect when a link between the module and the master controller has been severed.

23. A system according to claim 16, further comprising a local output device connected to the master controller; a communication unit operable to communicate test data to a remote device; and/or a communication unit operable to receive control signals from a remote device.

24. A system according to claim 23, wherein the local output device is a printer.

25. (canceled)

26. (canceled)

27. A system according to claim 16, wherein the master controller is operable to initiate tests at specific time intervals; and/or to initiate particular tests in response to specific user inputs or to vary the initiation schedule of particular tests in response to specific user inputs.

28. (canceled)

29. A method of testing a sprinkler system, the system comprising: one or more assemblies for testing a sprinkler system, and a master controller; each assembly comprising: testing apparatus; and a module, wherein the module is linked to the testing apparatus and is operable to: implement the test using the testing apparatus; report an outcome of the test and disable activation of a connected fire alarm during the test; the method comprising the steps of:
the master controller instructing the module of an assembly to begin the test;
the module of an assembly testing the sprinkler system by operating the testing apparatus; and
the module reporting the results of the test to the master controller.

30. (canceled)

31. (canceled)

32. (canceled)
